(19) United States
(12) Patent Application Publication
(10) Pub. No.: US 2020/0122503 A1
(43) Pub. Date: Apr. 23, 2020

(54) WHEEL ASSEMBLY WITH OPPOSED REMOVABLE BEAD LOCKS

(71) Applicant: Fredrick Taylor, Rome, GA (US)

(72) Inventor: Fredrick Taylor, Rome, GA (US)

(21) Appl. No.: 16/654,332

(22) Filed: Oct. 16, 2019

Related U.S. Application Data
(60) Provisional application No. 62/746,800, filed on Oct. 17, 2018.

(51) Int. Cl. B60B 25/04; B60B 25/20; B60B 25/08; B60B 3/10

(52) U.S. Cl. CPC B60B 25/045; B60B 25/20; B60B 2320/14; B60B 3/10; B60B 25/08

(57) ABSTRACT

A wheel assembly including a substantially cylindrical rim base with a varying thickness having first and second opposed annular edges, the rim base comprising first and second annular flanges formed on an outside surface of the rim base and respectively positioned at a distance set back from the first and second annular edges, each of the first and second annular flanges forming a first and second annular seat; first and second lock rings being substantially flat having a contact surface and an exterior surface, the contact surface of each lock ring configured to abut the respective annular edge; and a locking mechanism configured to removably secure the first and second lock rings to the first and second annular edges.

### CROSS-REFERENCE TO RELATED APPLICATION

This application claims the benefit of U.S. Provisional Application No. 62/746,800, filed Oct. 17, 2018, which is hereby incorporated by reference in its entirety.

### TECHNICAL FIELD

This disclosure relates to wheels for vehicles. More specifically, this disclosure concerns, a wheel assembly with two bolt on bead locks or a dual bead lock wheel, in particular for a vehicle for Lawn and Garden (L&G), Industrial (IND), utility, or off-road use.

### BACKGROUND

Tires for utility or industrial use are typically mounted on metal wheel rims that are essentially a one-piece construction. While pneumatic tires can be held on the rim by pressure, at times a particular vehicle use may require tires designed for specific applications, such as use of airless tires. There is a need, therefore, for a wheel rim for vehicles used in a manner such that it would be advantageous to secure the beads of airless tires to the wheel to prevent the beads of the tire from slipping or coming off the rim, in particular to a wheel for lawn and garden (L&G), industrial (IND), utility, or other similar off-road vehicles as described herein.

### SUMMARY

The present disclosure relates to wheel rim assemblies for vehicles, in particular for lawn and garden (L&G) vehicles, all-terrain vehicles (ATV), rough terrain vehicles (RTV), golf carts, utility vehicles, industrial, and skid steer vehicles. In various aspects, the present disclosure relates to wheels for vehicles used in a manner such that it would be advantageous to secure the beads of a tire to the wheel to prevent the beads of the tire from slipping, or coming off the rim of the wheel. The wheels and wheel assemblies disclosed herein can be configured to receive an airless tires, and the like, that may or may not have a low profile. However, other categories of tires can benefit from the secure fit of a wheel assembly with two removable bead locks as disclosed herein.

Briefly described, the present disclosure provides a wheel assembly with opposed removable bead locks designed to secure a tire to the wheel. In various non-limiting aspects, the wheel rim is a multi-piece lock ring design for vehicles for rough or off-road terrains. The vehicle can be an industrial vehicle such as lawn and garden (L&G) vehicles, all-terrain vehicles (ATV), rough terrain vehicles (RTV), golf carts, utility vehicles, industrial vehicles and skid steer vehicles, and the like. The wheel assembly can accommodate thick, wide, or extra wide beads. The wheel assembly is is not intended to be used with conventional pneumatic tires.

In a first embodiment, a wheel assembly is provided, the wheel assembly comprising: a substantially cylindrical rim base having first and second opposed annular edges, the rim base comprising first and second annular flanges formed on an outside surface of the rim base extending outwardly from the rim base and respectively positioned at a distance set back from the first and second annular edges, each of the first and second annular flanges forming in conjunction with the rim base a first and a second annular seat; first and second lock rings having a contact surface and an exterior surface, the contact surface of each lock ring configured to abut the respective annular edge; and a locking mechanism configured to removably secure the first and second lock rings to the first and second annular edges.

In any one or more aspects of the embodiment, in any combination, the first annular flange can have a substantially flat side which forms a wall of the first annular seat. The wall can be configured to form an angle α with the rim base that extends to the annular edge. The angle α of the annular seat ranges from 0 to 160 degrees. The wall can comprise at least one annular groove recess in the wall of the first annular seat facing the first annular edge. The flanges can have an inside surface extending outwardly from the rim base on the side of the flanges opposite the wall that forms a ramp at an angle β with respect to the rim base. The angle β can range from 0 degrees to 160 degrees. The first and second annular edges can comprise a plurality of fastener seats configured to receive a plurality of fasteners. The fasteners can be hex-head cap screws, socket cap screws, bolts, or similar fasteners. Each of the first and second lock rings can comprise a plurality of apertures. The apertures can be spaced circumferentially about the lock rings and configured to mate with the plurality of fastener seats in the respective annular edge. Each of the plurality of apertures on each of the first and second lock rings can comprise a countersunk seat concentrically positioned and configured to receive the head of a fastener. Either or both of the first and second annular seats can be generally L-shaped with a side of the annular flange being substantially flat forming a wall of the respective annular seat which is substantially perpendicular to the outside surface of the rim base. Either or both of the first and second lock rings can have an inner and outer diameter, the inner diameter being substantially the same as the inner diameter of the rim base at the annular edge. Either or both of the first and second lock rings can comprise a plurality of raised portions on an outside surface of the lock ring spaced circumferentially and configured to reinforce the locking mechanism. Each of the plurality of raised portions can be shaped to surround an aperture, in one of the lock rings. The aperture can be configured to mate with a fastener seat in a respective annular edge. The rim base can comprise an interior surface having a plurality of supports protruding radially inward and configured to receive a wheel center. The wheel center can be configured to be removably attached to the plurality of supports and further configured to mount the wheel assembly to an axis of a vehicle. The wheel center can comprise a plurality of spokes. Each of the spokes can have a mounting surface configured to be removably attached to the corresponding plurality of supports of the wheel rim. The rim base can be configured to receive a tire for a vehicle, the tire having a pair of tire beads, wherein the first and second annular seats are each configured to receive one of the tire beads. The tire can be secured to the rim base by securing the first and second lock rings to the first and second annular edges. The tire can be a pneumatic tire, a pneumatic style airless tire, a semi-pneumatic tire, or semi pneumatic with a divider effectively forming separate cavities.

In another embodiment, a method for mounting a tire is provided, the method comprising: placing a tire on the wheel assembly of the first embodiment, in any one or more of its aforementioned aspects in any combination thereof, wherein a first bead of the tire is seated in the first annular seat and a second bead of the tire is seated in the second annular seat; securing the first lock ring to the first annular edge of the rim base; and securing the second lock ring to the second annular edge of the rim base.

Other systems, methods, features, and advantages of the present disclosure for a wheel rim and assemblies will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates an exploded view of the wheel assembly with opposed removable bead locks according to various embodiments of present disclosure.

FIG. 2 illustrates an enlarged view of an exemplary locking mechanism comprising a fastener connection of a removable bead lock to a wheel rim of the wheel assembly with opposed removable bead locks shown in FIG. 1 according to various embodiments of present disclosure.

FIG. 3 illustrates a hub support within the inner surface of the wheel rim of the wheel assembly with opposed removable bead locks shown in FIG. 1 according to various embodiments of present disclosure.

FIG. 4 illustrates a partial side perspective view of a tire seated and secured by the wheel assembly with opposed removable bead locks shown in FIG. 1 including an attached hub according to various embodiments of present disclosure.

FIG. 5 illustrates a cross-sectional view of a peripheral portion of the wheel assembly shown in FIG. 4 with a tire installed and bead locks engaged according to various embodiments of present disclosure.

FIG. 6 illustrates a detailed view of a tire bead secured by a removable bead lock to a wheel rim according to various embodiments of present disclosure.

### DETAILED DESCRIPTION

Described below are various embodiments of the present systems and methods for a wheel and wheel assembly. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

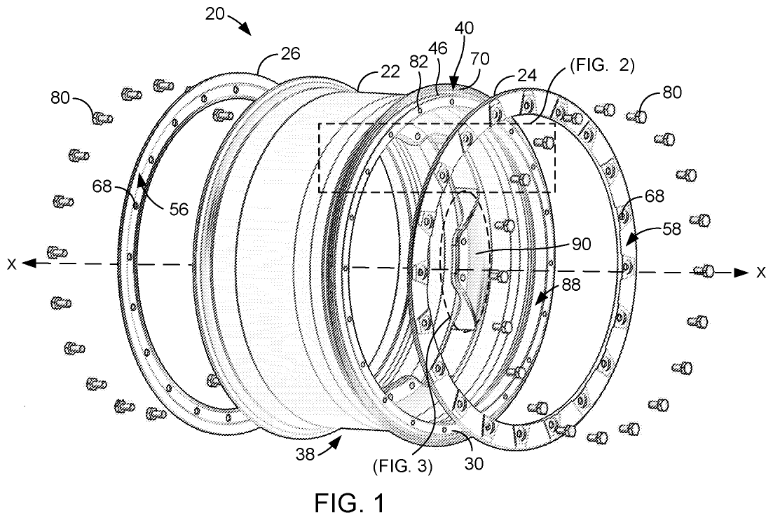

Referring now in more detail to the drawings, in which like numerals indicate like parts through the several views, FIG. 1 illustrates an example of a wheel assembly 20 with opposed removable bead locks in a partially exploded view depicting a wheel rim 22, a pair of opposed lock rings or bead locks 24, 26 and an exemplary locking mechanism comprising a plurality of fasteners 80 to secure the bead locks 24, 26 to the wheel rim 22. A center axis X-X is denoted for reference. In some embodiments, the inner diameter 60 of the lock ring is substantially similar to the inner diameter 64 of the rim base 22 at the annular edge 30,32.

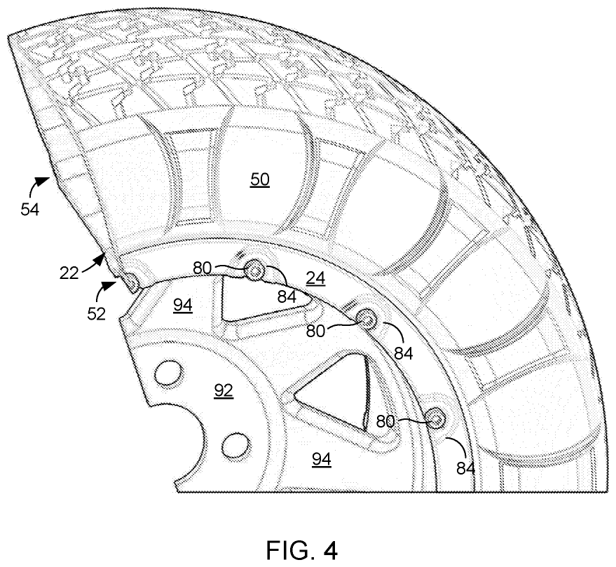

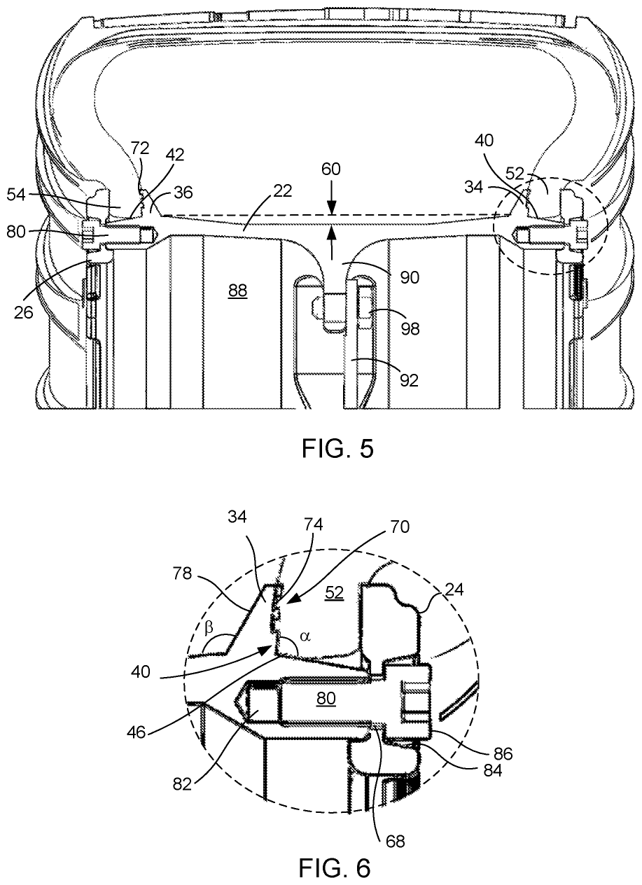

The wheel rim base 22 is a substantially cylindrical rim base 22 with a varying thickness having first and second opposed annular edges 30,32. In some embodiments, the wheel base 22 can be substantially symmetrical, where the thickness and features vary symmetrically from the centerline (not shown) to the annular edges 30,32. In some embodiments, the rim base 22 is asymmetrical with respect the centerline. The rim base 22 also includes first and second back breaks or annular flanges 34,36 (shown in FIG. 5) formed on an outside surface 38 of the rim base 22 and respectively positioned at a distance set back from the first and second annular edges 30,32, each of the first and second annular flanges 34,36 forming a first and second annular seat 40,42 in conjunction with a portion of the rim base 46,48. The annular seats 40,42 are configured to receive a tire 50 (shown in FIG. 5), in particular configured to hold the edges or beads of a tire 52,54 on the wheel rim base 22. The rim base 22 can further comprise an interior surface 88 having a plurality of supports 90 protruding radially inward and configured to receive a wheel center disc 92 (not shown in FIG. 1) or comprise a fully integral center disc 92 as depicted in FIG. 4, where the supports 90 and/or center disc 92 are configured as needed with respect to the equipment onto which the tire/wheel assembly would be installed. In various aspects, the wheel center, or center disc, can include a wheel hub (not shown) for mounting the wheel assembly to an axle of the vehicle.

The first and second lock rings 24,26 are configured to be removably attached or secured to the first and second annular edges 30,32. Each lock ring 24,26 has a contact surface 56 configured to abut and mate with the respective annular edge 30,32. In an aspect, the inner surface of the first and second lock rings 24,26 configured to contact the first and second annular edges 30,32 can be a substantially flat contact surface 56, and can have an exterior surface 58. In an aspect, annular edges 30,32 can be formed with a recess therein to receive a respective one of the lock rings 24,26 therein. In an aspect, the lock rings 24,26 can fit within the respective recesses in the annular edges 30,32 such that the outer or exterior surface 58 of the lock rings, once secured in place, is flush with an outer surface of the annular edges 30,32. The lock rings 24,26 can be configured to secure a tire 50 to the wheel rim 22, after the tire beads 52,54 have been positioned in their respective annular seat 40,42 using a locking mechanism configured to removably secure the first and second lock rings 24,26 to the first and second annular edges 30,32 of the rim base 22. In some embodiments, the lock rings 24,26 can include raised portions 66 configured to reinforce the locking mechanism. For example, raised portions 66 can be positioned on the exterior surface 58 of the lock rings and shaped around an aperture 68 in the lock rings 24,26 to increase the thickness of the lock ring at that position.

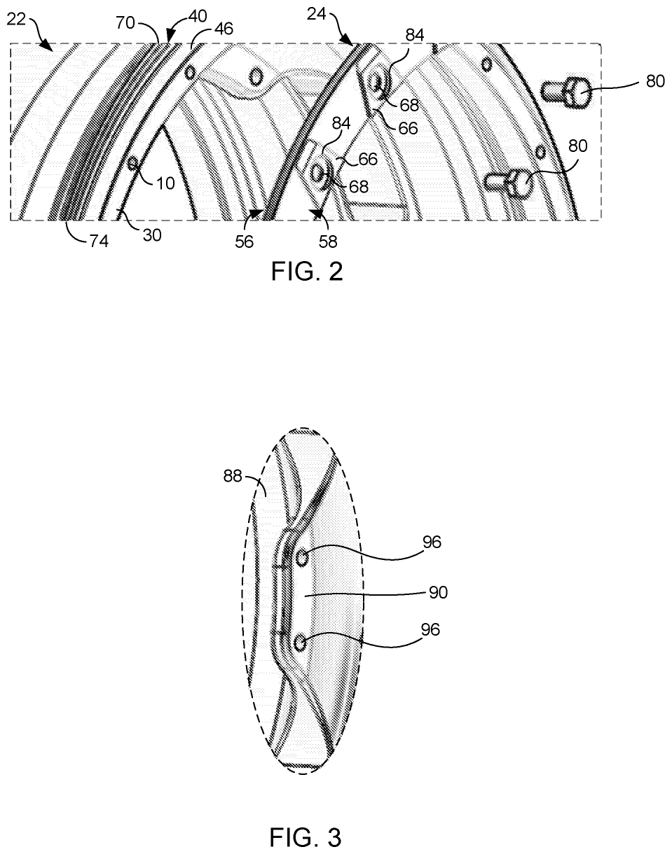

Shown in FIGS. 2, 5 and 6 are greater details of a portion of the annular seats 40,42 of FIG. 1. Each of the annular seats 40,42 of the rim base 22 are formed at an interior edge by an annular flange 34,36 and a portion of the rim base 46,48 extending to the annular edge 30,32 of the rim base 22 in conjunction with a respective opposed lock ring 24,26. Each annular flange 34,36 can have a substantially flat side on the surface of the flange facing an annular edge 30,32 which forms a wall 70,72 of each annular seat 40,42. The inside surface of the wall can be configured to form an angle with a portion of 46,48 the rim base 22 that extends to the annular edge 30,32. The seat angle α measured between the walls 70,72 with respect to their respective portion 46,48 of the rim base 22 of each annular seat 40,42 can range from 0 degrees (or no taper) to 180 degrees. In some embodiments, the seat angle α can range from 0 to 170 degrees, 0 to 160 degrees, 0 to 150 degrees, 0 to 120 degrees, 90 to 170 degrees, 90 to 150 degrees, or 90 to 120 degrees. In some embodiments, the wall of the annular seat further comprises at least one annular groove 74,76 in the wall 70,72 of the annular seat forming a channeled surface configured to engage with the tire beads 52,54 and aid in gripping and securing the tire beads 52,54 in place within their respective bead seat. Similarly, the interior surface of the lock rings 24,26 opposite the walls 70,72 can have a grooved surface (not shown) to aid in gripping and securing the tire beads 52,54. The flanges can also have an inside surface 78 extending outwardly from the rim base 22 on the side of the flanges opposite the walls 70,72 that can be formed at a ramp angle β with respect to the rim base 22 that can range from 0 degrees to 180 degrees. In some embodiments, the ramp angle β can range from 0 to 170 degrees, 0 to 160 degrees, 0 to 150 degrees, 0 to 120 degrees, 90 to 170 degrees, 90 to 150 degrees, or 90 to 120 degrees. The flanges 34,36, provide a number of benefits in addition to forming bead seats 40,42 for receiving and securing the beads 52,54 of a tire 50 to the wheel 20. The flanges 34,36 also serve as stiffening agents for the wheel, both for assembly and for use and operation of the wheel assembly. Further, the ramp angle β of the inside surface of the flanges 34, 36 can serve as a ramp to assist in the mounting for the tire bead(s) 52,54 into position within the bead seats 40,42. In some embodiments, there is a deviation 60 in the rim base 22 to further assist the mounting of the tire 50, as shown in FIG. 5 as a deviation from horizontal in a cross-sectional view.

Next, FIG. 3 illustrates greater detail of a support 90 shown in FIG. 1. The rim base 22 can further comprise an interior surface 88 having a plurality of supports 90 protruding radially inward. The plurality of supports can be configured to receive a wheel center 92. In this example, the wheel center 92 can be removably attached to the plurality of supports 90 and further configured to mount wheel assembly 20 to an axis of a vehicle, such as by a wheel hub. For example, the wheel center 92 can comprise a plurality of spokes 94, where each of the spokes 94 have a mounting surface configured to be removably attached to the corresponding plurality of supports 90 of the wheel rim 22. In the example shown, each of the supports 90 can include at least one support aperture 96 to secure the wheel center to the rim base 22 with at least one mounting bolt 98 or other fastening means.

In FIG. 4, a portion of a complete wheel assembly 20 is illustrated with a tire 50 mounted on the rim base 22 and a lock ring 24 mounted thereto. The wheel rim assembly 20 is configured to receive a tire 50 for a vehicle, where the first and second annular seats 40,42 are configured to receive the tire beads 52,54. Once the tire is mounted on the rim base 22 the tire 50 can be secured to the rim base 22 by placing the contact surface 56 of a bead lock ring against one of the annular edges 30,32 of the wheel rim 22, then securing the lock rings 24,26 thereto with the locking mechanism 80.

Another view of the wheel assembly 20 with a tire 50 mounted is illustrated in a cross sectional view in FIG. 5. In some embodiments, the locking mechanism comprises a plurality of fasteners 80 that are configured to be inserted through apertures 68 of a lock ring 24,26 and secured in fastener seats 82 of the rim base 22. For example, the rim base 22 can include a plurality of fastener seats 82 spaced circumferentially about and within the annular edges 30,32, with each fastener seat 82 configured to receive a fastener. The locking mechanisms or fasteners 80 can be hex-head cap screws, socket cap screws, bolts, or other similar fasteners. The lock rings 24,26 can include a plurality of apertures 68 spaced circumferentially and configured to mate with the plurality of fastener seats 82 in an annular edge 30,32. Each aperture 68 can be configured to receive a fastener 82. In some embodiments, the aperture 68 is further configured with a concentrically positioned countersunk seat 84 to receive the head of a fastener 86 (FIG. 6). In some embodiments, the annular edges 30,32 of the rim base 22 are further configured with one or more knobs and the lock rings 24,26 are further configured with indentations to receive the one or more knobs to prevent tire index when torque is applied.

Although a valve is not required for an airless tire, in some aspects a valve hole (not shown) can be formed within the wheel rim 22 to allow insertion of a valve stem. Although the tire will be fully sealed on the wheel, as operating temperatures rise, there can be a natural increase in pressure, similar to pneumatic tires on passenger car tires. In such operating conditions, this reaction can make an already stiff tire too stiff to operate within the vehicle manufacturer's expectation, and thus a valve may be needed to vent or relieve this pressure. In some aspects, installation of a Tire Pressure Monitoring System (TPMS) can also be accommodated for such applications that require monitoring of tire pressure.

In one or more aspects, tire 50 can be mounted onto the wheel by tilting bead 54 over the first back break or flange 34 on the first side of the wheel, such that the tire bead 54 is surrounds wheel rim 22. Using standard tire mounting tools, the first tire bead 54 is then pulled over the opposite or second back break 36. At this time, both tire beads 52,54 should be on the outside of the back breaks or flanges 34,36 on each side of the wheel unit within each of their respective bead seats 40,42 with the channeled surface 70,72 of the outer surface of the flanges 34, 36 in contact with the tire beads 52,54. The usage or application of a tire mounting lubricant can be dictated by the tire 50 depending on stiffness and/or other factors. See FIG. 5 for fitting representation, where a first bead 52 is seated in a first annular seat 40 in contact with wall 70 of the first flange 34 and a second bead 54 is seated in a second annular seat 42 in contact with wall 72 of the second flange 36. Bead lock rings 24 would then be installed as described herein.

It should be emphasized that the above-described embodiments are merely examples of possible implementations. Many variations and modifications may be made to the above-described embodiments without departing from the principles of the 25 present disclosure. All such modifications and variations are intended to be included herein within the scope of this disclosure and protected by the following claims.

Therefore, the following is claimed:

1. A wheel assembly comprising:
a substantially cylindrical rim base having first and second opposed annular edges, the rim base comprising first and second annular flanges formed on an outside surface of the rim base extending outwardly from the rim base and respectively positioned at a distance set back from the first and second annular edges, each of the first and second annular flanges forming in conjunction with the rim base a first and a second annular seat;
first and second lock rings having a contact surface and an exterior surface, the contact surface of each lock ring configured to abut the respective annular edge; and
a locking mechanism configured to removably secure the first and second lock rings to the first and second annular edges.

2. The wheel assembly of claim 1, wherein the first annular flange has a substantially flat side which forms a wall of the first annular seat, the wall configured to form an angle α with the rim base that extends to the annular edge.

3. The wheel assembly of claim 2, wherein the angle α of the annular seat ranges from 0 to 160 degrees.

4. The wheel assembly of claim 2, wherein the wall further comprises at least one annular groove recess in the wall of the first annular seat facing the first annular edge.

5. The wheel assembly of claim 1, wherein the flanges have an inside surface extending outwardly from the rim base on the side of the flanges opposite the wall that forms a ramp at an angle β with respect to the rim base.

6. The wheel assembly of claim 5, wherein the angle β from ranges from 0 degrees to 160 degrees.

7. The wheel assembly of claim 1, wherein each of the first and second annular edges further comprise a plurality of fastener seats configured to receive a plurality of fasteners.

8. The wheel assembly of claim 7, wherein the fasteners are hex-head cap screws, socket cap screws, bolts, or similar fasteners.

9. The wheel assembly of claim 7, wherein each of the first and second lock rings further comprise a plurality of apertures, the apertures being spaced circumferentially about the lock rings and configured to mate with the plurality of fastener seats in the respective annular edge.

10. The wheel assembly of claim 9, wherein each of the plurality of apertures on each of the first and second lock rings further comprise a countersunk seat concentrically positioned and configured to receive the head of a fastener.

11. The wheel assembly of claim 1, wherein each of the first and second annular seats are generally L-shaped with a side of the annular flange being substantially flat forming a wall of the respective annular seat which is substantially perpendicular to the outside surface of the rim base.

12. The wheel assembly of claim 1, wherein each of the first and second lock rings has an inner and outer diameter, the inner diameter being substantially the same as the inner diameter of the rim base at the annular edge.

13. The wheel assembly of claim 1, wherein each of the first and second lock rings comprise a plurality of raised portions on an outside surface of the lock ring spaced circumferentially and configured to reinforce the locking mechanism.

14. The wheel assembly of claim 13, wherein each of the plurality of raised portions are shaped to surround an aperture, in one of the lock rings, the aperture configured to mate with a fastener seat in a respective annular edge.

15. The wheel assembly of claim 1, wherein the rim base further comprises an interior surface having a plurality of supports protruding radially inward and configured to receive a wheel center, the wheel center configured to be removably attached to the plurality of supports and further configured to mount the wheel assembly to an axis of a vehicle.

16. The wheel assembly of claim 15, wherein the wheel center comprises a plurality of spokes, each of the spokes having a mounting surface configured to be removably attached to the corresponding plurality of supports of the wheel rim.

17. The wheel assembly of claim 1, wherein the rim base is configured to receive a tire for a vehicle, the tire having a pair of tire beads, wherein the first and second annular seats are each configured to receive one of the tire beads.

18. The wheel assembly of claim 17, wherein the tire is secured to the rim base by securing the first and second lock rings to the first and second annular edges.

19. The wheel assembly of claim 17, wherein the tire is a pneumatic tire, a pneumatic style airless tire, a semi-pneumatic tire, or semi pneumatic with a divider effectively forming separate cavities.

20. A method for mounting a tire comprising:
placing a tire on the wheel assembly of claim 1, wherein a first bead of the tire is seated in the first annular seat and a second bead of the tire is seated in the second annular seat;
securing the first lock ring to the first annular edge of the rim base; and
securing the second lock ring to the second annular edge of the rim base.
